(19) United States
(12) Patent Application Publication
(10) Pub. No.: US 2017/0019757 A1
(43) Pub. Date: Jan. 19, 2017

(54) GEOLOCATION DEVICE FOR A TELECOMMUNICATION SYSTEM

(71) Applicant: INTERSEC, PARIS LA DEFENSE CEDEX (FR)

(72) Inventors: JEAN-MARC COIC, BOURG LA REINE (FR); CHRISTOPHE NEZ, PARIS (FR)

(73) Assignee: INTERSEC, PARIS LA DEFENSE CEDEX (FR)

(21) Appl. No.: 15/123,849

(22) PCT Filed: Mar. 5, 2015
(86) PCT No.: PCT/FR2015/050544

§ 371 Date: Sep. 6, 2016

(30) Foreign Application Priority Data
Mar. 6, 2014 (FR) 1451822

(51) Int. Cl. H04W 4/02; G06Q 30/02; H04W 24/02

(52) U.S. Cl. CPC H04W 4/02; H04W 24/02; G06Q 30/0261

(57) ABSTRACT

The geolocation device comprises:

a requester (10) arranged to obtain signaling data associating identifiers of mobile communication devices (6) and signaling identifiers, at least some of the signaling identifiers designating a location cell,
a selector (12) arranged to determine a list of location cells neighboring a target location cell, based on the set of cells situated at a chosen distance from the target location cell, the chosen distance being defined in a metric manner or on the basis of the topology of the cellular network,
a sorter (14) arranged to select from the requester's data (10) at least one mobile communication device identifier (9) detected as being associated with a signaling identifier relating to a location cell belonging to the list of neighboring location cells determined by the selector (12), and
a tracker (16) arranged to launch active location cell monitoring of a mobile communication device (9) whose mobile device identifier has been selected by the sorter (14).

The invention relates to a geolocation device for a telecommunication system.

Cellphones have become products used by the population as a whole. Indeed, everyone old enough to be a consumer has a cellphone. This means that all businesses, particularly stores, can now communicate with their customers and prospects.

Numerous initiatives have been taken in this area, including, for example, the transmission of promotional SMS campaigns for attracting consumers to the point of sale. However, these campaigns, like mailshots, have a poor rate of return, since they are less targeted and do not take the consumer into account.

Other initiatives have been developed to improve the way in which the consumer is taken into account. Thus it has been found that an advertising SMS or one publicizing a promotion is more likely to succeed if the consumer is close to the point of sale. Consumers' cellphones are good indicators of their location. Methods of geolocation have therefore been developed.

These methods have adopted the main principles of “geofencing”: if a consumer enters an area close to a point of sale, a promotional SMS is sent to him.

However, many obstacles have been encountered.

Conventional geofencing methods are generally used on a limited number of elements to be monitored, which are identified. Active location monitoring of the elements to be monitored takes place: that is to say, the telecommunication network receives regular requests to indicate the exact location of a limited number of devices. In the present case, this method cannot be used, since the number of consumers is very large and their mobile devices are not known in advance. Moreover, the telecommunication network is unable to supply the location of each of its users at each instant.

Other methods have been adopted, based on the passive collection of data transmitted by the cellphone during its operation, collected at the network level. However, this method has a low success rate, because the consumer's entry into the perimeter concerned is detected too late, and the transmission of these data is irregular. Thus many potential consumers are missed by these methods.

The invention is intended to improve the situation. For this purpose, a geolocation device is proposed, comprising:

a requester arranged to obtain signaling data associating identifiers of mobile communication devices and signaling identifiers, at least some of the signaling identifiers designating a location cell,
a selector arranged to determine a list of location cells neighboring a target location cell, based on the set of cells at a chosen distance from the target location cell, the chosen distance being defined in a metric manner or on the basis of the topology of the cellular network,
a sorter arranged to select from the requester's data at least one mobile communication device identifier detected as being associated with a signaling identifier relating to a location cell belonging to the list of neighboring location cells determined by the selector, and
a tracker arranged to launch active location cell monitoring of a mobile communication device whose mobile device identifier has been selected by the sorter.

This device is highly advantageous, because it allows a reduction in the use of active monitoring, which consumes a large amount of hardware resources and makes impossible the use of geofencing on large populations (particularly populations which are inherently indeterminate), by using passive monitoring whose performance is inadequate when it is used on its own.

In some variants, the device may have one or more of the following characteristics:
the selector is arranged to determine the list of neighboring location cells, on the basis of the set of cells belonging to the same location area or the same routing area as the target location cell,
the tracker is arranged to perform active location cell monitoring of a mobile communication device whose mobile device identifier has been selected by the sorter at a frequency depending on the distance between a current location cell and the target location cell,
the tracker is also arranged to adjust the active monitoring frequency on the basis of an estimated speed of the device,
the tracker is arranged to perform active location cell monitoring of a mobile communication device whose mobile device identifier has been selected by the sorter according to a frequency depending on an estimated speed of the device, and
the tracker is arranged to adjust the active monitoring frequency when signaling data relating to a mobile device identifier selected by the sorter are received between two occurrences of active monitoring.

The invention also relates to a geolocation method comprising:
a) receiving signaling data associating at least one mobile communication device identifier and a signaling identifier designating a location cell,
b) determining whether received signaling data designate a location cell belonging to a list of location cells neighboring a target location cell and situated at a chosen distance from the target location cell, the chosen distance being defined in a metric manner or on the basis of the topology of the cellular network,
c) in response to a positive determination in step b), providing active location cell monitoring of a mobile communication device whose mobile device identifier is associated with the location data concerned.

In a variant, the list of neighboring location cells comprises solely cells belonging to the same location area or the same routing area as the target location cell.

Other characteristics and advantages of the invention will be more apparent from a perusal of the following description, based on non-limiting examples provided for illustrative purposes, and based on the drawings in which:

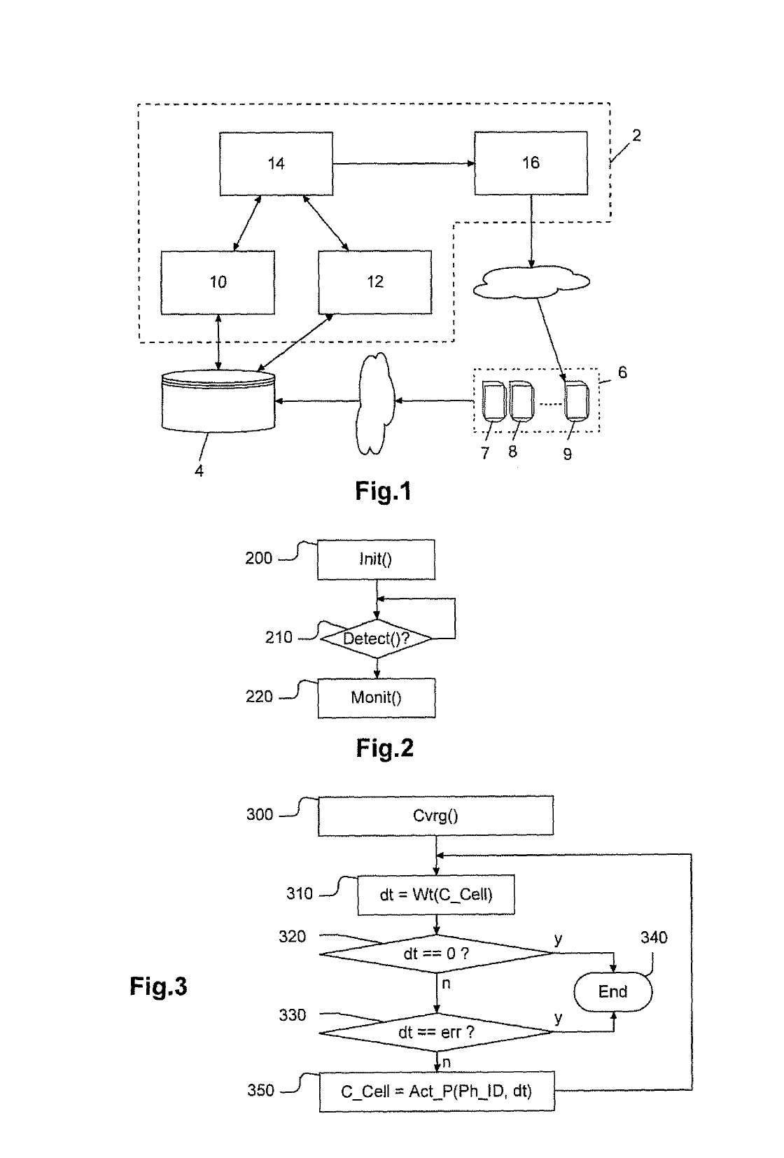

FIG. 1 shows a schematic diagram of a device according to the invention in its operating environment,

FIG. 2 shows a function executed by the device of FIG. 1,

FIG. 3 shows an exemplary embodiment of an operation of FIG. 2, and

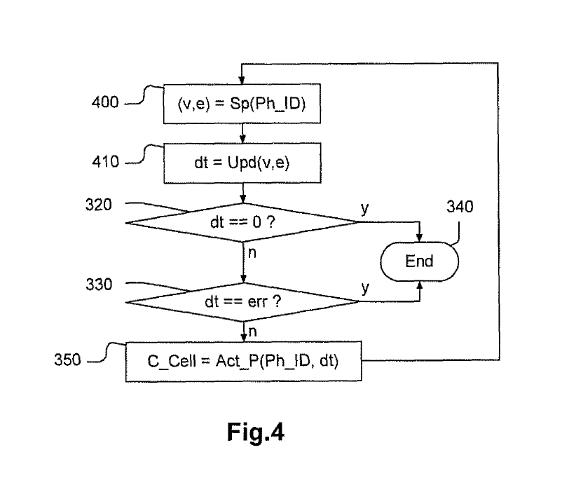

FIG. 4 shows another exemplary embodiment of the operation of FIG. 2.

The drawings and description provided below essentially contain elements of a defined nature. Consequently they can be used not only to clarify the understanding of the present invention but also to contribute to the definition of the invention if necessary.

The present description is such that it includes elements subject to protection by the law on authors' rights and/or copyright. The holder of the rights has no objection to the identical reproduction by any person of the present patent document or its description as it appears in official files. Regarding other elements, he reserves all his rights.

FIG. 1 shows a schematic diagram of a device according to the invention in its environment. As will be evident, the device 2 is particularly suitable for geolocation by geofencing of a large number of mobile communication devices whose location is not known in advance.

The device 2 interacts with a storage system 4 and with a plurality of mobile communication devices 6.

In the example described here, the storage system 4 belongs to a cellphone operator (using GSM, GPRS, EDGE, UMTS, LTE, or developments of these, or an extended WiFi network of the “hot spot” type). The storage system 4 contains all the signaling and activity data on one, some or all of the geographic areas served by the operator. The storage system 4 may be directly accessible or remote, may be distributed on one or more sites, and may be an aggregation of a plurality of separate storage systems, including those belonging to a plurality of operators who pool their resources.

In the example described here, the plurality of mobile communication devices 6 comprises a plurality of cellphones, three of which are referenced by 7, 8 and 9 respectively. As a general rule, any device connecting to a GSM, GPRS, EDGE, UMTS, or LTE cellphone network, or developments of these, or an extended WiFi network of the “hot spot” type may be considered as a mobile communication device 6.

The device 2 comprises a requester 10, a selector 12, a sorter 14 and a tracker 16. Each of these elements may be made in the form of an independent apparatus. Some of these elements—all of them in the example described here—may also be combined into a single apparatus. These elements may be hardware or software.

The device 2 and the storage system 4 on the one hand, and the plurality of mobile communication devices 6 on the other hand, are connected by clouds which are not referenced on FIG. 1. These clouds symbolize the fact that the connections are wireless. They also symbolize the whole infrastructure required for these connections.

As will be apparent from the following text, the device 2 uses a two-step geolocation strategy to provide effective geofencing of a large number of mobile communication devices which are not known in advance.

This strategy consists in defining a wide area surrounding the area of interest. In the wide area, monitoring is based on passive, permanently available data. If a mobile device enters this area, it is identified and the device 2 then establishes active monitoring of the identified device, until the device either leaves the wide area or enters the area of interest.

This makes it possible to use cellphones for marketing operations by geofencing around places chosen as brand locations. If an identified device enters the area of interest, an SMS or other message can be sent to offer it a promotion in the brand location to which it is close, thus facilitating a sale which would probably not have taken place in other circumstances.

In the following text, the area of interest is described a being a location cell known as the target. In a variant, the area of interest may be defined as a plurality of location cells. This definition does not change the way in which the wide area is defined, which may be adapted accordingly.

The requester 10 has the function of retrieving signaling data from the storage system 4. This retrieval may be active, that is to say that the requester 10 requests access to the storage system 4 (“pull”), or passive, that is to say that the requester 10 defines a process of communication with the operator's network such that the requester 10 receives the data automatically (“push”).

The term “passive retrieval” is taken to mean that the collection of users' locations by means of signaling data takes place without the need for generating specific signaling on the network, by contrast with active retrieval, which is carried out by specific requests or active monitoring as explained below.

The signaling data are stored in the form of pairs associating a signaling identifier (associated with a signaling event) and a mobile communication device identifier, each of these pairs designating a location cell. This association may be implicit or explicit, using identifiers, pairs or triplets. The term “identifier” is used here in its widest sense. Thus raw data may themselves form an identifier.

Signaling events comprise, for example, for a circuit switched network: “IMSI attach/detach”, “SMS MO/MT”, “Call MO/MT”, “Location update”, “Network lost”.

Signaling events comprise, for example, for a packet switched network: “Data session initiation/authentication”, “Data session interruption”, “Routing Area Update”.

The selector 12 has the function of accessing map data, for example data on the map of cells surrounding what is known as the target location cell, which contains the desired brand location. The selector 12 is arranged to define the wide area in the form of a list of neighboring cells surrounding the target location cell. In the example described here, this is done by accessing the storage system 4 which comprises the operator's map. In a variant, this may be done by other means. In a variant, the list of neighboring location cells is known and stored in a table which the selector 12 can access. In yet another variant, the selector 12 contains the map of the operator's installations and/or the definition of the wide area.

The sorter 14 has the function of cross-comparing the data from the requester 10 with the data from the selector 12, in order to detect the mobile communication devices entering the wide area. In the example described here, the phone 9 has been detected as having entered the wide area.

The tracker 16 has the function of actively monitoring the mobile communication devices identified by the sorter 14 as having entered the wide area. In the example described here, the tracker 16 interacts with the operator's infrastructure in accordance with the functions described below for performing the monitoring. In a variant, the tracker 16 may be a simple relay device for relaying the identifiers of these devices toward a tracker belonging to the operator.

FIG. 2 shows an example of a function executed by the device 2.

In a first operation 200, the device 2 initializes the geofencing. Thus, for a given monitoring operation, the selector 12 is called in a function Init( )to determine the list of neighboring location cells and the target location cell.

In the example described here, the selector 12 operates by defining the list of neighboring location cells as being:
the set of cells belonging to the “location area” to which the target location cell belongs, if the network is circuit switched, and
the set of cells belonging to the “routing area” to which the target location cell belongs, if the network is packet switched.

These sets of cells are relevant if signaling data of the “location update” or “routing area update” type are accessible. This is because, if these data are available, the transmission of corresponding signaling data indicates, by definition, entry into the wide area. If the area of interest comprises a plurality of target location cells, the wide area corresponds to the aggregation of the corresponding location or routing areas.

In a variant, if the signaling data of the “location update” or “routing area update” type are not accessible, the selector 12 can operate by selecting all the location cells which surround the target location cell, and of which at least a part is situated within a chosen radius surrounding the center of the target location cell, for example 3 km. In another variant, the list of neighboring communication cells may comprise the neighbors of the target location cell in the topological sense of the term, that is to say the set of cells that can be reached by contiguous displacement in three or four displacements or fewer. If the area of interest comprises a plurality of target location cells, the wide area may be calculated in a similar manner.

In another variant, the selector 12 may operate by a combination of these two variants, that is to say by selecting as neighboring location cells the location cells which surround the target location cell, and which belong to the same location area or the same routing area as the target location cell, and which are also situated within a chosen radius surrounding the center of the target location cell. Thus the two filters for selecting the neighboring cells complement one another in order to remove the location cells which are in the same location area or the same routing area but which would be too far from the target location cell, because of the network topology.

Additionally, the function Init( ) may also provide a call to the requester 10 to determine whether certain mobile communication devices are present in the target location cell, in order to communicate directly with these devices.

After the execution of the function Init( ) a loop is initiated in an operation 210. In this operation, a function Detect( ) is executed by the sorter 14 for the cross-comparison of the data collected by the requester 10 with the list of the neighboring location cells determined by the selector 12.

In the example described here, this is a matter of determining whether a signaling identifier designating one of the location cells on the list of neighboring location cells is present. This is because, if this identifier is present, then the associated mobile device identifier indicates a mobile communication device that has entered the wide area.

In a variant, the function Detect( ) is not executed as a loop. The device 2 is arranged to receive the signaling data from the storage system 4 in a passive manner (in “push” mode), and the function Detect( ) is initiated whenever signaling data are received.

If the sorter 12 determines that a mobile communication device has entered the wide area, a function Monit( ) is initiated in an operation 220.

FIG. 3 represents an example of the execution of the function Monit( ) of operation 220. In this function, the variable Ph ID denotes the identifier of the mobile communication device identified in operation 210, and the variable C_Cell is initialized with the identifier of the cell in which this device was located during the detection.

The function Monit( ) starts with an operation 300 in which a function Cvrg( ) is called. The function Cvrg( ) serves to calculate an active monitoring map within the wide area. The aim of this map is to adapt the active monitoring frequency on the basis of the distance between the detected location of the device and the target cell.

This is because the great majority of people use their cellphones while walking, at an average speed of 4 km/h. It is therefore useless to perform active monitoring every five minutes if the target cell is at a distance of several kilometers, for example. Thus the function Cvrg( ) starts from the target cell, and assigns a delay to each cell whose distance from the target cell is within a given range. This delay corresponds to the temporal spacing between two active monitoring operations. For example, the delay may be 2 minutes for cells situated less than 500 m from the target cell, 10 minutes for cells between 1 and 2 km from the target cell, 40 minutes for cells between 2 and 5 km from the target cell, and so on. In a variant, these values are fixed in advance, and the function Cvrg( ) accesses the corresponding table or recording.

When operation 300 has terminated, a variable dt, corresponding to the delay for the current location, is calculated by means of a function Wt( ) which receives the variable C_Cell as its argument. The function Wt( ) uses the cell identifier C_Cell to determine the corresponding delay that has been associated with it by the function Cvrg( ). In a variant, the function Wt( ) may check whether signaling data relating to the device have been received since the last request for active monitoring. If this is the case, a delay corresponding to the difference between the date of receipt of these data and the date of the last request for active monitoring may be added to the value of the variable dt.

Two tests are then performed in operations 320 and 330 to determine whether the active monitoring has to be terminated. This is because, if the variable dt is equal to 0, then the device is in the target area, and the specified action must be taken. Conversely, if the device has departed from the wide area, the variable dt receives the value err, indicating that the cell C_Cell has not been found in the list resulting from operation 300. Here again, the active monitoring should be terminated, because the device is no longer in the wide area. In both of these cases, the function Monit( ) terminates in an operation 340.

If neither of these two exit conditions is met, the function Monit( ) is prolonged into an operation 350 in which a function Act P( ) updates the variable C_Cell. The function Act P( ) receives as an argument the variable dt, as well as the identifier Ph_ID. It executes a wait loop whose duration is equal to the delay of the variable dt, then launches a procedure of active monitoring of the device that has the identifier Ph_ID, to update the current cell C_Cell.

Finally, the loop resumes with operation 310 and the calculation of a new delay suitable for the updated current cell C_Cell.

FIG. 4 shows an example of the execution of the function Monit( ) of operation 220 in a variant.

In this variant, operations 320 to 350 are unchanged. The main difference is that, in this variant, a speed vector of the movement of the device and a corresponding error are determined before the delay dt is varied.

For this purpose, in an operation 400, the tracker 12 determines a current speed v and a corresponding error e, using a function Sp( ) which receives the identifier Ph_ID as an argument. This determination can be executed by comparing locations determined in the recent past, as well as by integration of a history list of the device's movement. Thus the precision can be improved on frequent paths.

After operation 400, the variable dt is updated by a function Upd( ) in an operation 410, using as its arguments the speed v and the error e determined in operation 400. Thus, if the speed vector indicates that the device is approaching the target cell, the delay dt can be decreased, in order to increase precision. Conversely, if the speed vector indicates that the device is moving away from the target cell, the delay dt can be increased. The increase/decrease of the delay may also depend on the magnitude of the speed, of the estimated error, and of the distance between the current cell and the target cell. When the exit tests have been performed and the current cell has been updated in operation 350, the loop resumes with operation 400.

The variants of FIGS. 3 and 4 may be combined. For example, it is possible to determine a delay dt as a function of the current cell, then to adjust this delay more finely on the basis of the estimated speed. It is also possible, on the basis of the speed, to determine that the carrier of the device has changed his mode of transport, and the function Cvrg( ) may be re-executed to allow for the new speed, and provide a more appropriate active monitoring map.

In the above description, numerous functions have been described in relation to specific examples. It should be noted that these functions may be executed in various ways, notably by being divided or grouped together, and some operations may thus be rendered optional. Similarly, some of the functions described above can be combined with one another, and some variables can be replaced. The scope of the present text covers all these variants, whether they are described explicitly or implicitly.

Finally, some functions have been described according to a paradigm of the “push” or “pull” type. If only one paradigm has been mentioned, this does not mean that the other paradigm is not included in the scope of the invention, and persons skilled in the art should consider the application of this other paradigm, if there is no obvious contradiction of the principles of the invention.

In view of the above, it appears that the invention can be used to provide an offer of localized services based on geofencing for a very large population that is not known in advance, something that has not been possible hitherto.

1. A geolocation device, comprising:
a requester (10) arranged to obtain signaling data associating identifiers of mobile communication devices (6) and signaling identifiers, at least some of the signaling identifiers designating a location cell,
a selector (12) arranged to determine a list of location cells neighboring a target location cell, based on the set of cells situated at a chosen distance from the target location cell, the chosen distance being defined in a metric manner or on the basis of the topology of the cellular network,
a sorter (14) arranged to select from the requester's data (10) at least one mobile communication device identifier (9) detected as being associated with a signaling identifier relating to a location cell belonging to the list of neighboring location cells determined by the selector (12), and
a tracker (16) arranged to launch active location cell monitoring of a mobile communication device (9) whose mobile device identifier has been selected by the sorter (14).

2. The device as claimed in claim 1, wherein the selector (12) is arranged to determine the list of neighboring location cells on the basis of the set of cells belonging to the same location area or the same routing area as the target location cell.

3. The device as claimed in any of the preceding claims, wherein the tracker (16) is arranged to perform active location cell monitoring of a mobile communication device (9) whose mobile device identifier has been selected by the sorter (14) at a frequency depending on the distance between a current location cell and the target location cell.

4. The device as claimed in claim 3, wherein the tracker (16) is also arranged to adjust the active monitoring frequency on the basis of an estimated speed of the device.

5. The device as claimed in claim 1 or 2, wherein the tracker (16) is arranged to perform active location cell monitoring of a mobile communication device (6) whose mobile device identifier has been selected by the sorter (14) according to a frequency depending on an estimated speed of the device.

6. The device as claimed in any of claims 3 to 5, wherein the tracker (16) is arranged to adjust the active monitoring frequency when signaling data relating to a mobile device identifier selected by the sorter (14) are received between two occurrences of active monitoring.

7. A geolocation method, characterized in that it includes:
a) receiving signaling data associating at least one identifier of a mobile communication device (6) and a signaling identifier designating a location cell,
b) determining whether received signaling data designate a location cell belonging to a list of location cells neighboring a target location cell and situated at a chosen distance from the target location cell, the chosen distance being defined in a metric manner or on the basis of the topology of the cellular network,
c) in response to a positive determination in step b), providing active location cell monitoring of a mobile communication device (9) whose mobile device identifier is associated with the location data concerned.

8. The method as claimed in claim 7, wherein the list of neighboring location cells comprises solely cells belonging to the same location area or the same routing area as the target location cell.
